(19) United States
(12) Patent Application Publication
(10) Pub. No.: US 2026/0276063 A1
(43) Pub. Date: Sep. 17, 2026

(54) SPLIT TORQUE GEARBOX WITH VARIABLE BACKLASH CONTROLLER

(71) Applicant: PRATT & MILLER ENGINEERING AND FABRICATION, LLC, New Hudson, MI (US)

(72) Inventors: Joseph KENNEY, Farmington, MI (US); Andy FRIAR, Howell, MI (US); William KIDD, Canton, MI (US); Kevin KWIATKOWSKI, Ann Arbor, MI (US)

(73) Assignee: PRATT & MILLER ENGINEERING AND FABRICATION, LLC, New Hudson, MI (US)

(21) Appl. No.: 19/667,869

(22) Filed: May 5, 2026

Related U.S. Application Data
(60) Provisional application No. 63/767,231, filed on Mar. 5, 2025.

(51) Int. Cl. F16H 1/28; F16H 1/46

(52) U.S. Cl. CPC F16H 1/2863; F16H 1/46

(57) ABSTRACT

A split torque gearbox is provided with a phase controller present between two legs of the gearbox which is controllable to lock together the two legs for a high precision operation or unlocked between the two legs to allow them to operate in an open condition for hi torque and speed. The system provides a gearbox capable of delivering both high torque high-power and high-speed motion at an output and high precision by operation of a backlash controller.

### CROSS-REFERENCE TO RELATED APPLICATIONS

This application claims the benefit of priority under 35 U.S.C. §119 to United States Provisional Patent Application No.63/767,231, filed March 5, 2025, the content of which is incorporated herein by reference in its entirety.

### FIELD OF THE INVENTION

The present invention is related to a gearbox arrangement for operating an actuated element providing operating modes for both high-power and precision motion.

### BACKGROUND

There are numerous applications in the design of machinery and equipment in which it is desired to actuate a member for spatial movement driven by a rotary power source such as an electric motor. The actuated member may be, as examples; the arm of a robot, working components of construction equipment, container stacking systems, inventory pick and place systems, vehicle loading equipment, factory robotic systems, etc. For such applications, it is desirable to provide a drivetrain which provides both high actuation speed and power but at an end point of travel, the actuated element may be required to be positioned and moved with high accuracy. There are inherent design trade-offs for these divergent specifications; high-speed and power generally are inherently at the expense of accuracy. One cause of such trade-offs is attributable to the use of mechanical gear trains which have inherent backlash characteristics. Backlash is necessary to reduce stress in gear train components when required for a high rate of speed and power. Backlash also ensures that gears do not result in hard interference as the material of the gears expand by heating during use. Backlash also insures lubrication can coat the gear teeth during use and remove heat from the meshing interfaces. As the number of gear meshes increases in an assembly, the total backlash from input to output can result in a significant number of unwanted conditions. These conditions can consist of gear clunking during input and output torque reversals, and a loss of accuracy in high precision applications. Reducing backlash can be accomplished but generally results in high wear and stress on gear train components.

There are various approaches employed in accordance with the prior art for dealing with the trade-offs of high speed and power, and spatial accuracy for the positioning of an actuated element. One approach is to use precision gears incorporating close-tolerance parts and special bearings and housings. Precision gear assemblies typically limit backlash to about 2 degrees and require individual matched components. Such systems are highly labor intensive to manufacture and are generally limited for very low torque applications such as instrumentation.

Examples of modified designs for backlash control utilize various methods such as short center distance between gears, spring loaded gears, plastic fillers, tapered gears, and preloaded gear trains. These various methods typically are used in either low torque applications or require periodic adjustment to maintain their close tolerance.

Dual path gear trains are an effective solution for miniature spur gear trains. The gears rotate in opposite directions to force mating teeth together. This method does result in near zero backlash but is applicable for very light load precision applications.

### SUMMARY OF EXEMPLARY EMBODIMENTS OF THE INVENTION

By utilizing a variable backlash controller in a gearbox in accordance with the present invention, with a dual-path (split) power transmission system, the gearbox can transition from a high torque mode to a high precision movement mode.

Split torque gearboxes or a known configuration and may be used to meet packaging requirements and other constraints in the design of a powertrain system. By utilizing multi-paths in the gear train arrangement, lower torque requirements are imposed in each of the paths or legs of the system. The present invention exploits an opportunity for backlash control provided by a split powertrain system.

In an embodiment of the present invention, a split gearbox system is provided in which power delivered by a prime mover such as an electric motor or modulated through a friction brake is first split by a gear differential into two separate parallel paths. A variable backlash controller consisting, as an example, of a stacked gear meshes with both of the legs of the powertrain circuit and utilizes an actuating mechanism producing a phase difference between the two gears of the backlash controller which loads the powertrain legs against one other to effectively reduce backlash to near zero. One example of such a backlash controller is a hydraulic system which produces the phase difference and is controlled via supplied control hydraulic pressure. In a high rate/high-power operating mode, the two drivetrain legs can be effectively decoupled with their inherent backlash characteristics to drive the actuated element. However, when a high precision mode is required, the backlash controller can preload the gear train legs against one another, effectively reducing backlash to extremely low levels.

### BRIEF DESCRIPTION OF THE DRAWINGS

FIG. 1 is a diagrammatic view of a split torque gearbox in accordance with an embodiment of the present invention.

FIG. 2 is the pictorial view of a hydraulic controller assembly used with the gearbox shown in FIG. 1.

FIG. 3 is a partial cross-section and pictorial view cut through the hydraulic controller assembly of FIG. 2.

FIG. 4 is a pictorial view of the upper gear of the hydraulic controller assembly.

FIG. 5 is a pictorial view of the lower gear of the hydraulic controller assembly.

### DETAILED DESCRIPTION OF THE EMBODIMENT OF THE INVENTION

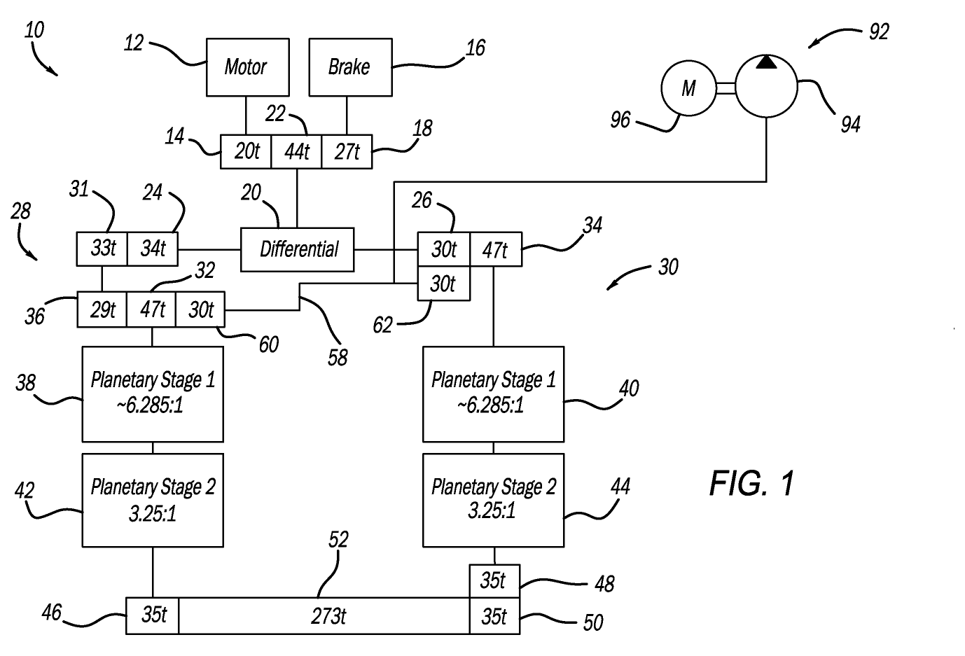

FIG. 1 is a diagrammatic illustration of a split torque gearbox 10 in accordance with the present invention. Components of gearbox 10 are described from a power input to a power output of the system. FIG. 1 illustrates certain gear tooth counts and pitches for a particular application, designated by a tooth count number such as, for example “27t” representing a gear with 27 teeth. Alternate applications of the present invention can use a variety of different final gear reduction values, and various gear reduction stages and gear types to provide desired output performance output specifications. The particular parameters illustrated and described are not essential elements of the present invention. Torque is applied into the system by motor 12 which in most instances would be an electric motor in an exemplary embodiment. Motor 12 is coupled with differential input gear 14. Brake 16 is provided for cooperating with motor 12 to provide positioning and control of an actuated element and is coupled with differential input gear 18.

In order to provide a torque split into two legs of the gear train system, differential 20 is provided. Differential 20 may be of various types but in all instances provides the ability to balance torque between two outputs from a rotary input. Familiar examples of gear differentials are present in rear axles of the rear wheel drive motor vehicles utilizing bevel gears and straight cut gear types found in front wheel motor vehicle drive applications. For this invention, numerous alternative configurations of differentials 20 may be implemented. In this example, differential input gears 14 and 18 drive differential ring gear 22. The outputs of differential 20 are through gears 24 and 26 which supply power between split first and second legs of the powertrain system; designated by reference numbers 28 and 30, respectively. In first leg 28, gear 31 is coupled with gear 36 which is provided to ensure the proper rotational direction between the legs necessary, as will be explained as follows.

Although differential 20 is illustrated as a discrete unit, gears 22, 24 and 26 comprise gears which are components of the differential. Differential output gears 24 and 26 respectively mesh with first and second leg input gears 32 and 34. In one embodiment of the present invention, slightly different gear ratios are present between first and second legs 28 and 30 which is evident from the illustrated gear tooth count of the drives into the two stages. Although it is desirable to balance torque between the two legs, a slight difference in drive ratios into the first and second legs 28 and 30 provides a degree of relative rotation of gears comprising differential 20. This prevents differential 20 from simply being in a static condition in which specific gear tooth interfaces are always loaded. This is an issue since, as will be described, first and second legs are locked together at their outputs and accordingly if precisely equal torque is applied into each legs with identical drive ratios, differential 20 could become geared into a static configuration. Such a static configuration could cause excessive wear at certain gear mesh interfaces.

For each leg 28 and 30, rotational power is coupled with first stage planetary gear sets 38 and 40 and second stage planetary gear sets 42 and 44, respectively. The outputs of the second stage planetary gear sets 42 and 44 are coupled with output gears 46 and 48. Gear 50 is provided on one side for providing proper rotation direction. Both legs are coupled to gearbox output gear 52 which drives a load, depending on application.

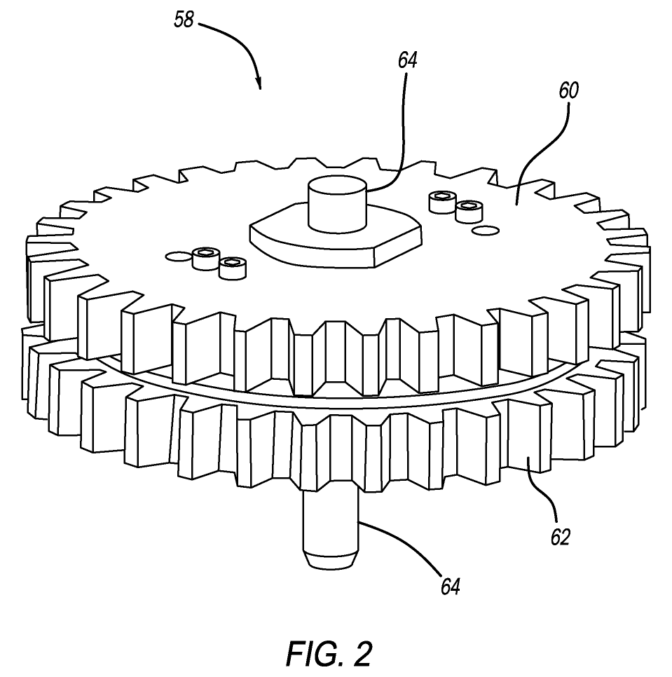

The above described features of split torque gearbox 10 are generally in accordance with prior art teachings. A significant aspect of the present invention is the provision of phase controller 58 which provides a meshing gear connection between the gearbox legs 28 and 30 just after differential 20 in terms of power flow. Phase controller 58 provides a meshing gear connection between the two legs but provides a phase adjustment such that the two legs can be locked or biased against one another in a manner that significantly reduces backlash. Various configurations of variable phase controllers can be provided; one of them is illustrated with reference to FIGS. 2-5.

Phase controller 58 is shown in pictorial view FIG. 2 illustrating two gears 60 and 62 which are shown in FIG. 1 as meshing with the inputs of the first and second legs 28 and 30 into the planetary gear reduction stages. Gears 60 and 62 of phase controller 58 are piloted on rotating spindle 64. Phase controller 58 is capable of providing a controlled relative rotation between gears 60 and 62 within a prescribed number of degrees which enables the loading or locking together of the two legs. Additional components of controller 58 include bushing 84, lock nut 82, thrust plate 83 and sealing ring 80.

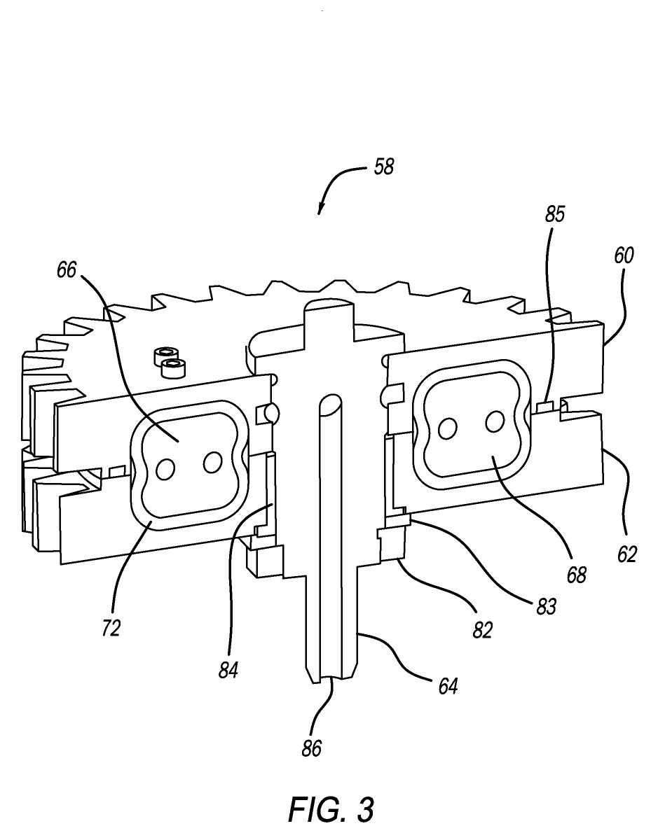

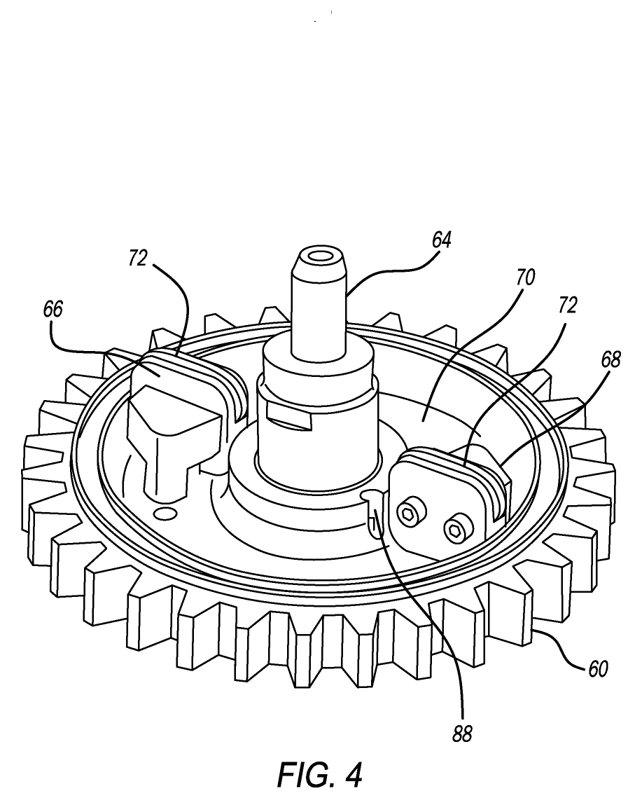

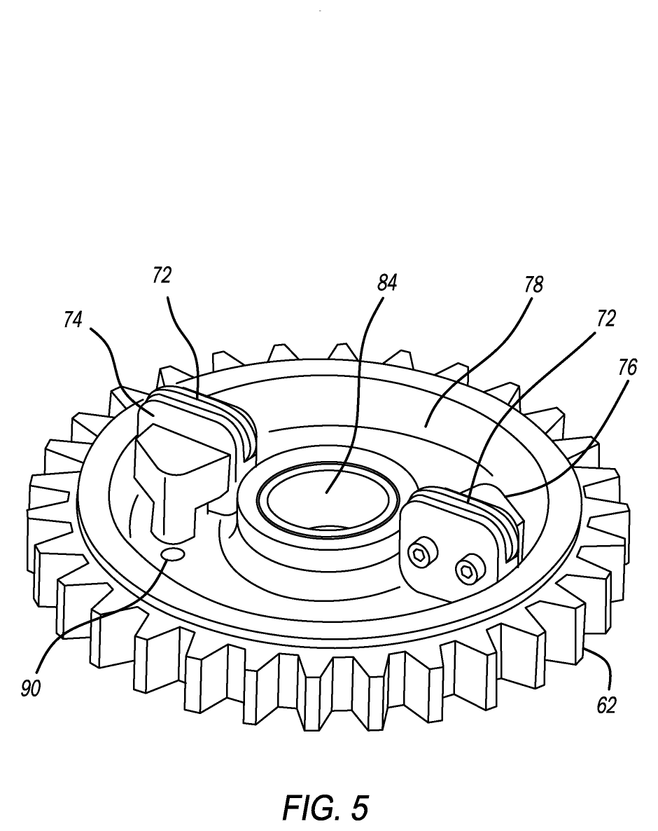

FIG. 3 provides a cut away illustration through phase controller 58 and shows the presence of the paddle assemblies 66 and 68 within troughs 70 or partial circular cavities formed by the surfaces of gears 60 and 62 which face one another. FIG. 4 shows upper gear 60, shown flipped over forming the circular trough 70 and the presence of two paddle assemblies 66 and 68 which each include a paddle seal 72 with the lower half of paddle seals 72 sealing against circular trough 70. Paddle assemblies 66 and 60 are physically mounted in position to gear 60. Lower gear 62 is shown in FIG. 5 and likewise includes a pair of paddle assemblies 74 and 76 with seals 72 which also match within the corresponding trough 78 of the lower gear. When the two gears are assembled the configuration of FIG. 3 is provided. Paddle assemblies 66, 68, 74 and 76 are intermeshed so that they do not interfere through a prescribed arc of relative rotation. When the two gears 60 and 62 are assembled a fluid seal is provided by sealing ring 80 and closed hydraulic chambers of variable displacement volumes are defined between respective paddle assemblies of gears 60 and 62 and the gear troughs 70 and 78.

It should be noted that in an alternative embodiment of the present invention gears 60 and 62 could be replaced by disk-shaped elements which do not form gear teeth themselves but are rather coupled directly or indirectly to gears which mesh with first and second leg input gears 60 and 62.

Gears 60 and 62 are piloted by spindle 64 which is fixed to one of the gears, in this case gears 60 whereas the other gear 62 is piloted for relative rotation with respect to the spindle via bushing 84. A fluid feed path 86 is provided within spindle 64 and supplies hydraulic fluid via fluid feed ports 80 into the enclosed volumes. On an opposite side of the enclosed volume are drain holes 90 which allow any fluid hydraulic leaking past paddle seals 72 to be drained into the gearbox sump. By controlling the applied pressure to fluid feed ports 88, the volume of the two chambers changes and a relative rotation is produced between gears 60 and 62. Since they are each separately meshing with the two drivetrain legs 28 and 30, they effectively lock together the two legs in a manner which produces extremely low backlash.

Controlled hydraulic pressure is provided to phase controller 58 by hydraulic controller 92 which could be for example a piston driven positive displacement pump 94 or other mechanism driven by motor 96 for providing a control hydraulic pressure to controller 58.

It should be recognized that various alternative configurations for phase controller 58 may be provided which would result in similar advantages as that provided by the exemplary embodiment. For example, motor driven actuators, cam profiles and other configurations can be used with which can provide a controlled relative rotation between the two gears 60 and 62 of the phase controller meshing with the two legs of the split torque gearbox.

In the operation of the split torque gearbox 10 two operating modes are available. In a high torque, high-speed first mode, phase controller 58 is not actuated by hydraulic controller 92 to lock together the two legs. Instead, the two legs act independently with their inherent backlash characteristics to provide torque to drive gear 52. However, if high precision is required in a high precision mode, phase controller 58 can be actuated to lock together the two legs to provide near zero backlash. Torque applied by motor 12 and brake 16 would be limited in such a second operational mode to limit year wear and component limits when operating in a reduced backlash condition.

It should be noted that phase controller 58 is present in the system after the differential 20. Accordingly, there is no backlash reduction upstream of the two legs provided by phase controller 58. However, in the application illustrated, the high gear reductions present in the drives of the two legs and the series planetary gear sets results in the backlash present at the output associated with the differential to be extremely low.

While the above description constitutes a preferred embodiment of the present invention, it will be appreciated that the invention is susceptible to modification, variation and change without departing from the proper scope and fair meaning of the accompanying claims.

What is claimed is:

1. A split torque gearbox comprising;
a rotational input,
a differential coupled with the rotational input and providing first and second differential outputs,
a first gear train leg having at least one gear reduction stage driven by the first differential output,
a second gear train leg having at least one gear reduction stage driven by the second differential output,
the first and second gear train legs coupled to a gearbox output, and
a variable phase actuator engaging with both the first and second gear train legs mechanically coupling the gear train legs together, wherein the actuator phase between the gear train legs is variable to reduce backlash at the gearbox output.

2. The split torque gearbox in according to claim 1 further comprising; a motor coupled with the rotational input.

3. The split torque gearbox in according to claim 1 further comprising; a brake coupled with the rotational input.

4. The split torque gearbox in according to claim 1 further comprising; the gear reduction stages of the first and second gear train legs comprising one or more planetary gear reduction stages.

5. The split torque gearbox in according to claim 1 further comprising; the variable phase actuator engaging the first and second gear train legs before the gear reduction stages of the first and second gear train legs.

6. The split torque gearbox in according to claim 1 wherein the variable phase actuator further comprising; first and second disc elements stacked together with the first disc element coupled with the first train leg and the second disc element coupled with the second train leg and with the actuator enabling the rotational phase of the first and second disc elements to be variable.

7. The split torque gearbox in according to claim 6 further comprising; the variable phase actuator disc elements forming one or more semi-annular chambers closed at two ends by first and second seal elements and a controllable supply of a hydraulic fluid to the one or more chambers for causing the volume of the one or more chambers to be varied thereby causing the angular phase relationship of the two disc elements to change thereby changing the rotational relative angular phase of the first and second disc elements.

8. The split torque gearbox in according to claim 6 further comprising; the first and the second disk elements comprising first and second gears meshing respectively with the first and second gear train legs.

9. The split torque gearbox in according to claim 6 further comprising, first and second gear train sets coupled with the first and second differential outputs and having meshing gears providing a gear reduction value different from one another thereby causing a relative rotation between the differential first and second differential outputs.
